(19) United States
(12) Patent Application Publication
(10) Pub. No.: US 2019/0322154 A1
(43) Pub. Date: Oct. 24, 2019

(54) AIR CONDITIONING CONTROL SYSTEM

(71) Applicant: Microsoft Technology Licensing, LLC, Redmond, WA (US)

(72) Inventor: Arnab GANGULY, Renton, WA (US)

(73) Assignee: Microsoft Technology Licensing, LLC, Redmond, WA (US)

(21) Appl. No.: 15/957,814

(22) Filed: Apr. 19, 2018

(51) Int. Cl. B60H 1/00

(52) U.S. Cl. CPC B60H 1/00742; B60H 1/00871

(57) ABSTRACT

An air conditioning control system includes a plurality of air vents in a space and a plurality of sensors configured to generate sensor input including an estimated temperature of at least one target surface of an occupant or object in the space. The system further includes one or more processors configured to execute a thermal control model to generate airflow parameters for each vent based on the sensor input, to control the estimated temperature to trend toward a respective target temperature for each target surface. The air vents may be installed in a vehicle, and the plurality of sensors may be installed in the vehicle or be installed in, or be an accessory of, a mobile computing device.

### BACKGROUND

Vehicles often include air conditioning systems to heat or cool the vehicle interior by controlling the flow and temperature of air. When automated, such systems typically utilize a known external temperature and a measured interior temperature to adjust the air introduced to the interior. However, conventional air conditioning systems fail to account for the comfort of the occupants in the air-conditioned space and the variances in temperature throughout the space. For example, a passenger on the sunny side of a vehicle may be warmer than a passenger on the shaded side, but both passengers are equally air-conditioned. This one-size-fits-all approach to climate control often leads to wasted energy and low comfort levels.

### SUMMARY

To address the issues discussed above, an air conditioning control system is provided that includes a plurality of air vents in a space and a plurality of sensors configured to generate sensor input including an estimated temperature of at least one target surface of an occupant or object in the space. The system may further include one or more processors configured to execute a thermal control model to generate airflow parameters for each vent based on the sensor input, to control the estimated temperature to trend toward a respective target temperature for each target surface. In one aspect, the air vents may be installed in a vehicle. The plurality of sensors may be installed in the vehicle or be installed in, or be an accessory of, a mobile computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a top view of an air conditioning control system installed in a vehicle.

FIG. 2 shows a schematic view of the air conditioning control system.

FIG. 3 shows an illustration of a computing device of the vehicle communicating with a mobile device and a mounted camera.

FIG. 4 shows an exemplary graphical user interface of the air conditioning control system.

FIG. 5 is a flowchart of a method for air conditioning control.

FIG. 6 is a flowchart of a method for energy efficient routing of a vehicle.

FIG. 7 shows an illustration of a navigation system for use with the method of FIG. 6.

FIG. 8 is an example computing system according to an embodiment of the present description.

### DETAILED DESCRIPTION

Many local building codes and standards (e.g., American Society of Heating, Refrigerating and Air-Conditioning Engineers (ASHRAE) Standards 62.1 and 62.2) require ventilation rates based on occupancy. The occupancy of a space is sometimes estimated through CO₂ sensors for demand controlled ventilation (DCV). The present inventors have found that while CO₂-based DCV may estimate the overall occupancy level of a vehicle based on exhalation rates, the amount of CO₂ exhaled remains the same regardless of each individual passenger's discomfort and thus DCV fails to anticipate comfort-based heating and cooling needs. In addition, variances in temperature throughout the air-conditioned space are overlooked and thus inefficient heating or cooling is applied to the space. The systems and methods described herein have been devised to address these challenges, and, as discussed below, offer the advantage of providing personalized air conditioning and heating that is potentially quick, energy efficient, and responsive to the comfort of the occupants of the space.

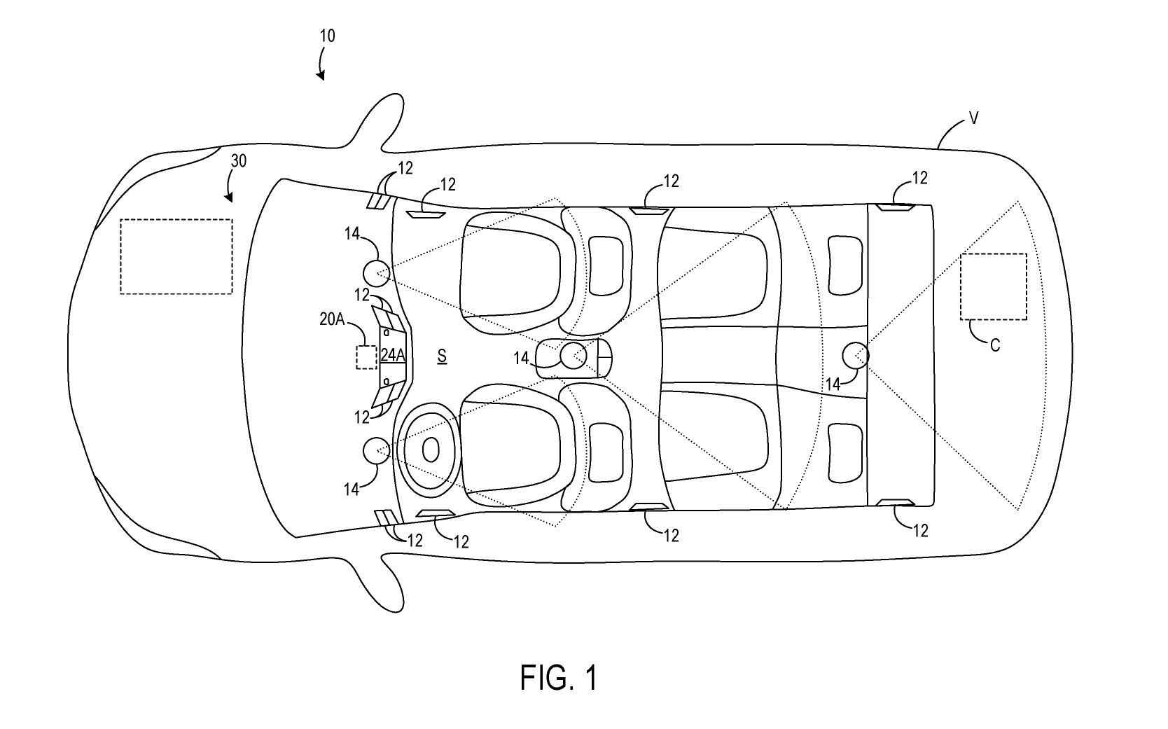

FIG. 1 shows a top view of an air conditioning control system 10 installed in a vehicle V. The air conditioning control system 10 may include a plurality of air vents 12 in a space S. In one aspect, the vents 12 may be motorized vents that can be controlled to direct air along a specified vector, also known as swivel vents or oscillating vents. In another aspect, the vents 12 may be stationary, and the lack of directional movement may be compensated for by increasing the number of vents 12 in the space S. As illustrated in FIG. 1 by way of example, the air vents 12 may be installed in a vehicle V such as an automobile. However, the air conditioning control system 10 may be adapted for use in a variety of environments including homes, other buildings, trains, busses, marine vessels, etc.

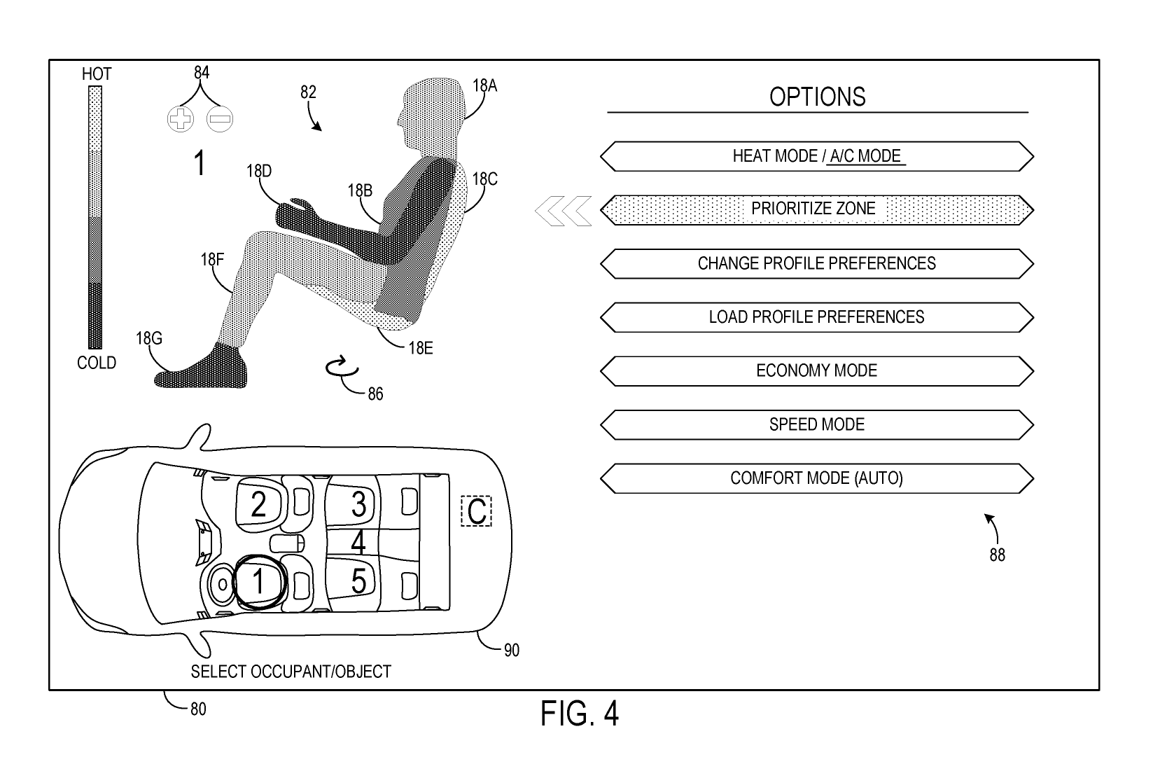

The air conditioning control system 10 may include a plurality of sensors 14 configured to generate sensor input including an estimated temperature 16 of at least one target surface 18A-G (see FIG. 4) of an occupant or object C in the space S. For example, the plurality of sensors 14 may include one or more of a thermal sensor, a visible-light camera, and a thermographic camera. Additionally, sensors such as a CO₂ sensor, a cabin temperature sensor, an external temperature sensor, a global positioning system (GPS) receiver, an optical sensor, and/or a pressure sensor may be included to augment the processing performed by the air conditioning control system 10. An exemplary range of each sensor 14 is shown in FIG. 1 in dotted lines, which may depend on which type of sensor 14 is included. One sensor 14 may be used per occupant or tracked object C, which may facilitate distributed processing and preference tracking via a personal device for each passenger, for example. Alternatively, multiple occupants or objects C may be sensed by the same sensor 14 when the targets are close enough in range for this configuration to be feasible. In this manner, the number of electronic devices included in the system may be reduced without decreasing the quality of personalized air conditioning, particularly when utilized in a region typically occupied by children, such as the back seats of the vehicle V. Still alternatively, multiple sensors 14 may be used to measure more target surfaces 18A-G of an individual occupant or object C than a single sensor 14 is able to measure, increasing the degree of personalization and precision of the air conditioning control system 10.

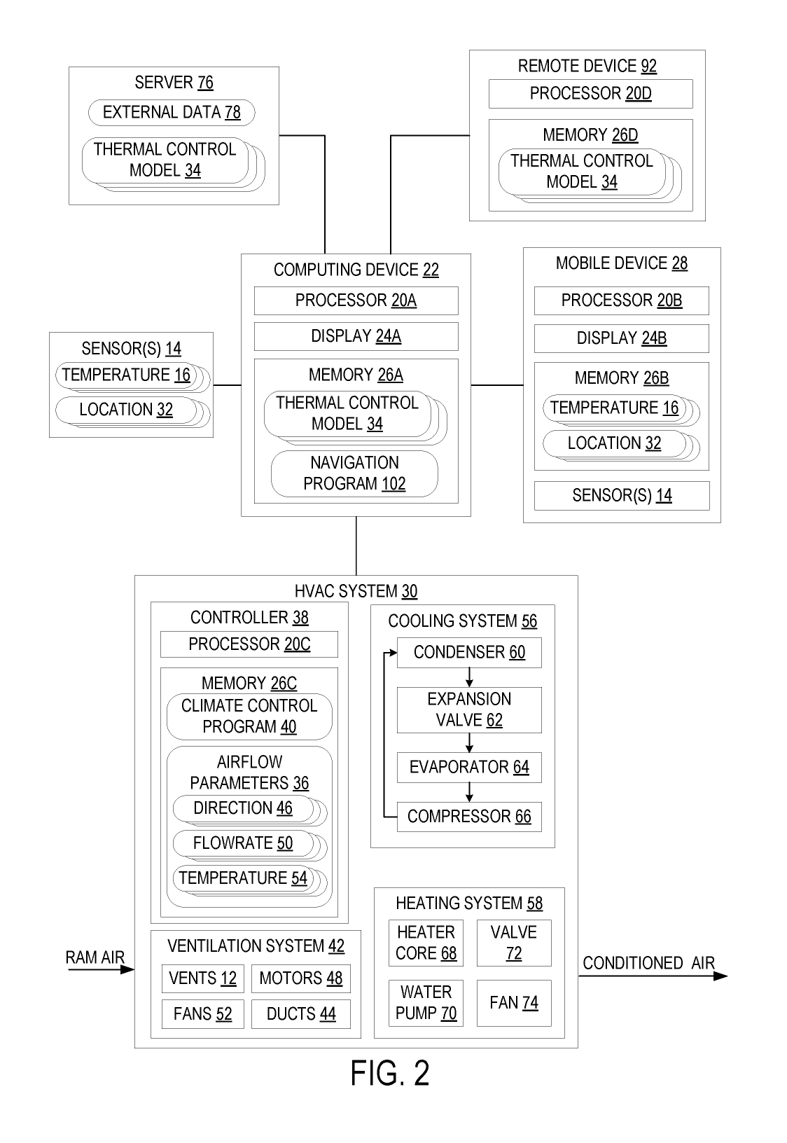

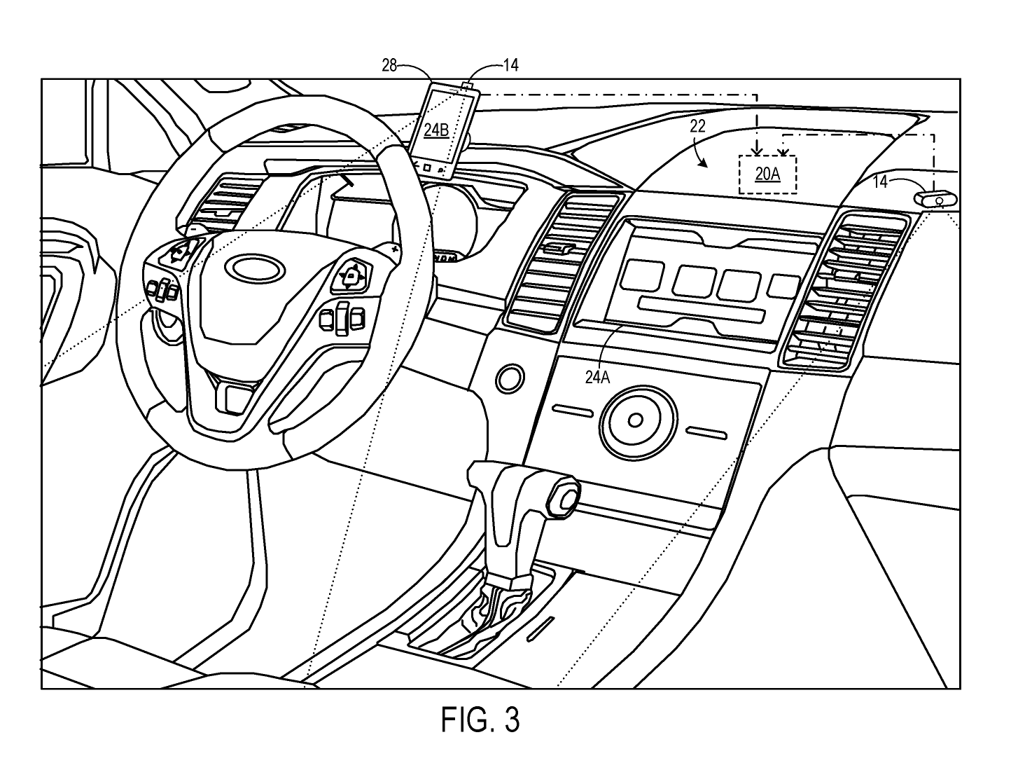

FIG. 2 shows a schematic view of the air conditioning control system 10. The air conditioning control system 10 may include one or more processors 20A-D. For example, the air conditioning control system 10 may include a computing device 22 having the processor 20A, a display 24A, and memory 26A. The display 26A may be, as shown in FIG. 3, installed in the dashboard of the vehicle V as a center console. However, the processor 20A may instead be separate from the processor responsible for controlling the center console.

In some cases, one or more of the plurality of sensors 14 may be installed in, or be an accessory of, a mobile computing device 28. The mobile device 28 may additionally include the processor 20B, a display 24B, and memory 26B. The mobile device 28 may be a smartphone, tablet, or handheld electronic gaming device, to provide merely a few examples. A Heating Ventilation and Air Conditioning (HVAC) system 30 may be controlled by one of the one or more processors 20A-D. As illustrated here, the HVAC system 30 includes the processor 20C, but it will be appreciated that aspects of the processor 20C may be combined with the processor 20A such that the HVAC system 30 is directly controlled by the computing device 22. In addition, the processor 20B of the mobile device 28 may be able to send instructions to the HVAC system 30 using suitable software.

In addition to the temperature 16, the sensor input may further include a three-dimensional location 32 of the at least one target surface 18 in the space S. The location 32 of each target surface 18 may be used to track the occupant or object C as it moves or is moved about the space S, and also to locate each target surface 18 even when stationary. One aspect of tracking the occupant or object C may include image recognition from images captured by the sensors 14. Once recognized, the tracked occupant or object C may be provided with continuous air conditioning without interruptions due to confusion with another occupant or object C.

The one or more processors 20A-D may be configured to execute a thermal control model 34 to generate airflow parameters 36 for each vent 12 based on the sensor input, to control the estimated temperature 16 to trend toward a respective target temperature for each target surface 18. The computing device 22 may generate the airflow parameters 36 to be sent to the HVAC system 30, or may instruct a controller 38 of the HVAC system 30 to generate the airflow parameters 36 based on intermediary data by executing a climate control program 40 stored in memory 26C. The target temperature may be programmatically determined by the air conditioning control system 10 or the user may manually set the target temperature.

The HVAC system 30 may include a ventilation system 42 including the vents 12 and associated ducts 44 connecting the vents 12 to other components of the HVAC system 30 for air transfer. The airflow parameters 36 may dictate various aspects of the air emitted by the HVAC system 30 on a per-vent basis. For example, the airflow parameters 36 may include a flow direction 46 of air flowing through each vent 12 that is independently adjustable by a motor 48 controlled by one of the one or more processors 20A-D. Each vent 12 may have an associated motor 48, or some vents may share motors 48. Using the flow direction 46 the air conditioning control system 10 may be able to direct the flow of air through motorized vents 12 to precise locations within the vehicle V. The airflow parameters 36 may include a flowrate 50 of air flowing through each vent 12 that is independently adjustable by a fan 52 controlled by one of the one or more processors 20A-D. Each vent 12 may have an associated fan 52, or some vents may share fans 52. Accordingly, not just the direction 46 of the air, but also the volumetric flowrate 50 of the air may be individually controlled for each vent 12.

In addition, the airflow parameters 36 may include a temperature 54 of air flowing through each vent 12 that is independently adjustable by the HVAC system 30. The temperature 54 may be adjusted through conventional means including cooling by a cooling system 56 and heating by a heating system 58. It will be appreciated that as used herein, “air conditioning” may refer to both heating and cooling. For cooling, the cooling system 56 may cycle refrigerant through a condenser 60, an expansion valve 62, an evaporator 64, and a compressor 66. For heating, the heating system 58 may pass coolant from an engine of the vehicle V through a heater core 68 using a water pump 70 and a valve 72 to control the amount of coolant directed toward the heater core 68. A fan 74 may be used to force air past the heater core 68 to thereby effect heat transfer from the core 68 to the air before the air is introduced to the interior of the vehicle V. Thus, the temperature of the cooled or heated air may be set according to the various temperatures 54 of the airflow parameters 36. In addition, unheated and uncooled ram air may be mixed with either the cooled or heated air at various ratios in order to provide different vents 12 with different temperatures 54 of air at the same time.

The thermal control model 34 may be pre-set and stored locally in the memory 26A associated with the one or more processors 20A-D. Such a pre-set model 34 may be the default model 34. The thermal control model 34 may instead be generated by the one or more processors 20A-D based on factors such as CO₂ output, time of year, time of day, age of passengers, medical conditions, geographic location, climate, route chosen on a navigation system of the computing device 22, type of cargo detected, or user input, etc. Some of these factors may be obtained from a server 76 as external data 78. Alternatively, the thermal control model 34 may be downloaded from the server 76 among a plurality of models 34 based on the sensor input. Different models 34 may be suitable depending on current circumstances, similarly to the generation of models 34 discussed above. While FIG. 1 shows an example where the object C being tracked is cargo in the trunk of the vehicle V, the air conditioning control system 10 may also be used in a non-passenger vehicle such as a refrigerated truck. In such a situation, a model 34 suitable for maintaining surface temperatures 16 of all objects C in the truck below a safe threshold as a target temperature may be selected. Similarly, refrigerated or frozen cargo in a passenger vehicle may be kept at an effective temperature to avoid spoilage as a target temperature.

FIG. 3 shows an illustration of the computing device 22 of the vehicle V communicating with the mobile device 28 and a mounted camera as the sensor 14. The sensor 14 of the mobile device 28 may be an added accessory or may be built-in, such as a phone camera. In the illustration, the sensor 14 of the mobile device 28 may be a thermal sensor used in conjunction with the built-in camera. From images captured by the camera, a three-dimensional distance from the sensor 14 to each target surface 18 may be determined. Using this distance, air directed at each target surface 18 may continue to be so directed even if the occupant or object C, in this case, the driver of the vehicle V, moves. The mobile device 28 then communicates the captured temperature and location data as sensor data to the computing device 22, where the sensor data is used by the thermal control model 34 to control the HVAC system 30. Alternatively, with the appropriate software, the mobile device 28 may be configured to process the thermal image data locally and then instruct the HVAC system 30 directly. The mobile device 28 may be configured to communicate with the computing device 22 via a hardware cable or mount, or wireless mechanisms such as internet, near-field communication (NFC), or BLUETOOTH wireless technology standard. Communication systems of the vehicle V used for security, emergency services, or hands-free calling may be utilized as well. Shown at the right of FIG. 3 is the sensor 14 in the form of a mounted thermographic camera capable of capturing thermal images of the front passenger. The display 24A and/or mobile device 28 may be configured to receive user input, as discussed below.

FIG. 4 shows an exemplary graphical user interface (GUI) 80 of the air conditioning control system 10. The GUI 80 may be displayed on display 24A or display 24B, for example. For each occupant or object C, the one or more processors 20A-D may be configured to generate and update a thermal map 82 over time. The thermal map 82, or thermal profile, includes the temperature 16 and location 32 of various target surfaces 18 or zones of the occupant or object C. This thermal map 82 may be continuously updated as both temperature and location change. The GUI 80 may display the thermal map 82 or may display a generic profile without a thermal component for simplicity. Here, the user is informed of the varying temperatures of different zones on their body. GUI elements 84 may be used to zoom in or out, while element 86 may be used for three-dimensional rotation of the thermal map 82.

Once the user selects one or more zones for prioritization, for example, target surface 18A, this zone will be heated or cooled most intensely compared to the remaining zones. Accordingly, the vents 12 may be controlled to direct air at the location 32 where the target surface 18A is determined to be located, and the heating system 58 or cooling system 56 will adjust the temperature 54 and flowrate 50 of the air exiting nearby vent(s) 12 appropriately. Even without user selection, each target surface 18A-G may be individually treated in accordance with the current mode. For example, occupant l's left arm is relatively cold, and may be in the shade. By contrast, occupant l's right arm may be relatively hot in the sun, perhaps as hot as occupant l's face. The air conditioning control system 10 may be configured to automatically cool the hot zones quickly and not waste energy cooling the already cold zones, thereby also decreasing the occupant's discomfort.

The precise airflow parameters 36 may be determined by the current mode and the target temperature. Options menu 88 illustrates a few example options. For instance, speed mode may cool the hot zones and any medium zones quickly to the detriment of fuel economy, while economy mode may set a minimum temperature as the target temperature based on a minimum threshold of comfort level that should be provided and conserve energy by only cooling the hottest zones necessary to achieve the minimum threshold. Comfort mode, the default mode, may set a higher threshold of comfort level to be provided than the minimum threshold, but still use less energy than in the speed mode by cooling less intensely, that is, at a warmer temperature 54 and/or lower flowrate 50. The comfort levels and target temperatures may be determined according to the thermal control model 34 chosen based on default settings, adjusted by user input, and/or updated by machine learning.

Other options accessible via the GUI 80 may include switching between pre-set heating and A/C modes, changing the profile preferences, and loading a saved profile from the server 76 or mobile device 28, to provide merely a few examples. Any of the illustrated options may be omitted or altered as they are merely provided for example. The air conditioning control system 10 may also include pre-programmed modes prioritizing fuel (or electric charge) efficiency versus speed of temperature changes, and may include a default comfort mode programmatically set between the economy and speed modes. At the bottom left of FIG. 4 is a diagram of the vehicle V that may be usable as an occupant/object selection element 90. As illustrated, five occupants and one cargo item are carried in the vehicle V. Once selected, information regarding each occupant/object C may be viewed and individual preferences may be adjusted.

Alternatively to the local control using the GUI 80, the computing device 22 may be configured to communicate with a remote device 92 having a processor 20B and memory 26B such that the HVAC system 30 may be remotely controllable. This configuration may be a security feature—for example, for the refrigerated truck described above, or for an emergency vehicle such as an ambulance. Alternatively, remote control of the HVAC system 30 may be desirable for passengers of self-driving cars as a premium service, for example.

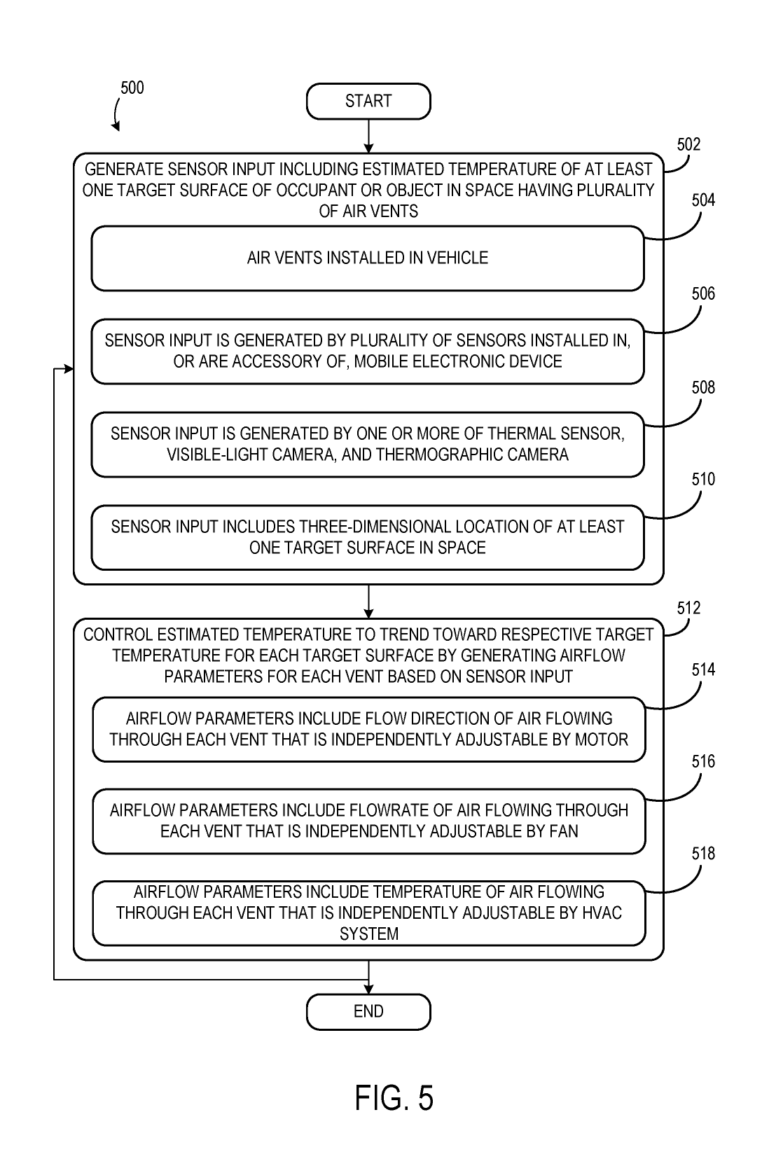

FIG. 5 shows a flowchart of a method 500 for air conditioning control. The following description of method 500 is provided with reference to the air conditioning control system described above and shown in FIGS. 1-4. It will be appreciated that method 500 may also be performed in other contexts using other suitable components.

With reference to FIG. 5, at 502, the method 500 may include generating sensor input including an estimated temperature of at least one target surface of an occupant or object in a space having a plurality of air vents. At 504, the air vents may be installed in a vehicle. Alternatively, the space may be in a building such as a home or office, for example. At 506, the sensor input may be generated by a plurality of sensors that are installed in, or are an accessory of, a mobile computing device. At 508, the sensor input may be generated by one or more of a thermal sensor, a visible-light camera, and a thermographic camera. Additional sensor input may be generated by, for example, a CO₂ sensor, a cabin temperature sensor, an external temperature sensor, or a global positioning system (GPS) receiver. At 510, the sensor input may further include a three-dimensional location of the at least one target surface in the space. Obtaining the location and temperature of the target surfaces may allow the air conditioning control system to track and intelligently heat or cool individual target surfaces rather than uniformly heating or cooling the entire space or large zones, e.g., when front vents are turned on by occupants but rear vents are turned off when not in use.

At 512, the method 500 may include controlling the estimated temperature to trend toward a respective target temperature for each target surface by generating airflow parameters for each vent based on the sensor input. The individualized airflow parameters may allow for precise and efficient control of the HVAC system so that important areas (e.g., faces or backs touching seats) may be prioritized and cooled first and most intensely compared to body parts that do not contribute to discomfort as strongly, such as lower legs, in the case of cooling the space. At 514, the airflow parameters may include a flow direction of air flowing through each vent that is independently adjustable by a motor. At 516, the airflow parameters may include a flowrate of air flowing through each vent that is independently adjustable by a fan. At 518, the airflow parameters may include a temperature of air flowing through each vent that is independently adjustable by a Heating Ventilation and Air Conditioning (HVAC) system. Additional airflow parameters may include, for example, a duration of airflow and tiered temperatures so that once a target temperature is reached, a second, less severe temperature is used next. After 512, the method 500 may end, or may return to 502 to gather additional sensor input as an iterative process.

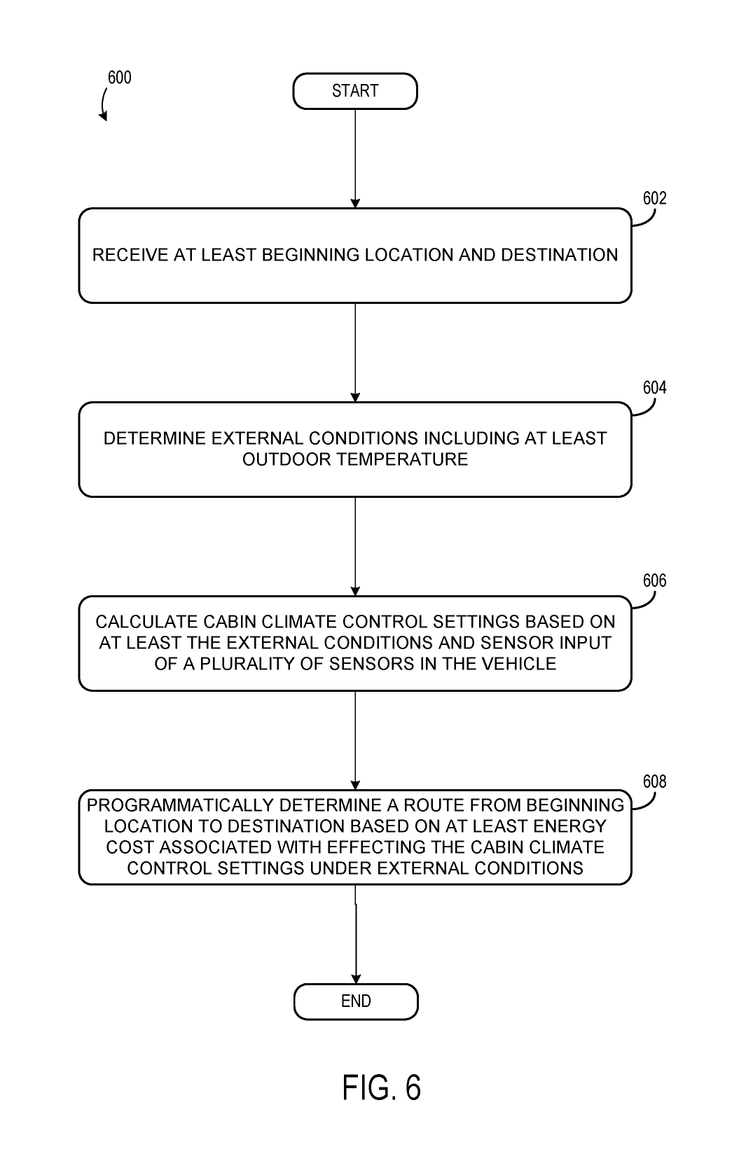

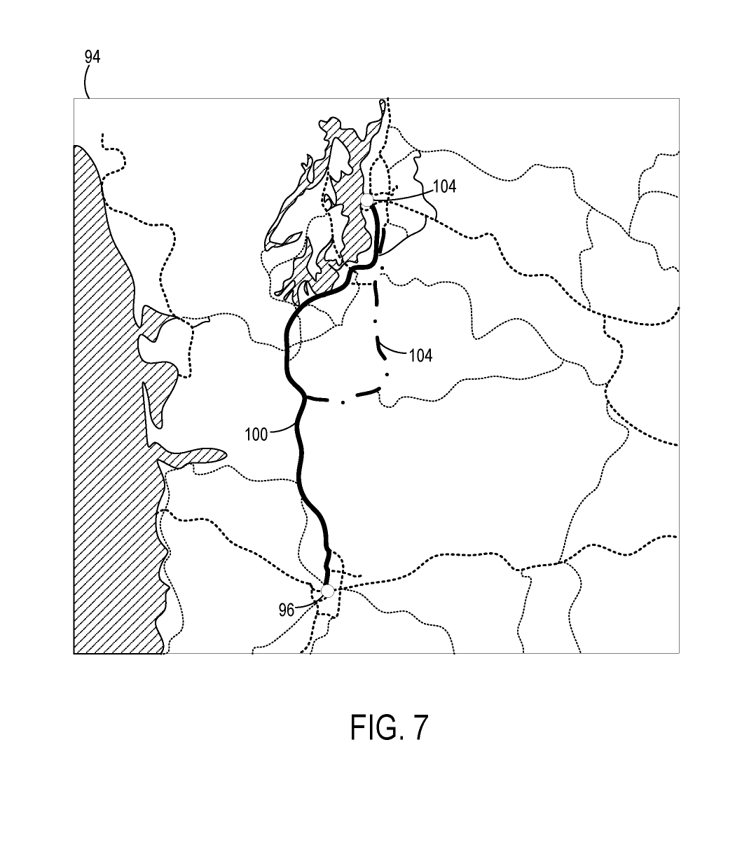

FIG. 6 shows a flowchart of a method 600 for energy efficient routing of a vehicle in view of the energy costs of air conditioning the vehicle using the systems and methods discussed above. The following description of method 600 is provided with reference to the air conditioning control system described above and shown in FIGS. 1-4, as well as the navigation map 94 shown in FIG. 7. It will be appreciated that method 600 may also be performed in other contexts using other suitable components.

With reference to FIG. 6, at 602, the method 600 may include receiving at least a beginning location 96 and a destination 98. At 604, the method 600 may include determining external conditions including at least an outdoor temperature. Other exemplary external conditions may include time of year, time of day, sunlight direction and intensity, nearby topographical features and buildings and their interaction with sunlight and temperature at the time the vehicle may pass by a given location, pollen count, air quality (e.g., due to smog or other pollution effects), and so on.

At 606, the method 600 may include calculating cabin climate control settings based on at least the external conditions and sensor input of a plurality of sensors in the vehicle. The sensor input may be similar to the sensor input discussed above. At 608, the method 600 may include programmatically determining a route 100 from the beginning location 96 to the destination 98 based on at least an energy cost associated with effecting the cabin climate control settings under the external conditions. The route 100 may be determined by, for example, the processor 20A executing a navigation program 102. As illustrated in FIG. 7, the route 100 is chosen over a route branch 104. The map 94 may be generated on a hot summer day and the nearby bodies of water may provide a cooling effect that results in lower temperatures along the lakes (hatched lines) as estimated at the time of predicted travel through the route 100, compared to the route branch 104 which would direct the vehicle through the middle of empty landscape without shelter from the hot sun. Under these circumstances, the route 100 would require less energy in the form of fuel to maintain the cabin of the vehicle at the same comfortable temperature as compared to the route branch 104. Accordingly, the method may select the route 100 based on at least the associated energy cost when providing navigation for the driver.

The systems and methods described above include individual vents controlled based on, for example, direction, temperature, and flowrate of the air exiting therefrom. The occupants and objects may be tracked with thermographic imaging to build thermal profiles so that individual surfaces of the occupants and objects may be targeted with precise control. These configurations may provide occupants of a space, or objects stored therein, with personalized climate control that is energy efficient while still quickly reducing occupant discomfort.

In some embodiments, the methods and processes described herein may be tied to a computing system of one or more computing devices. In particular, such methods and processes may be implemented as a computer-application program or service, an application-programming interface (API), a library, and/or other computer-program product.

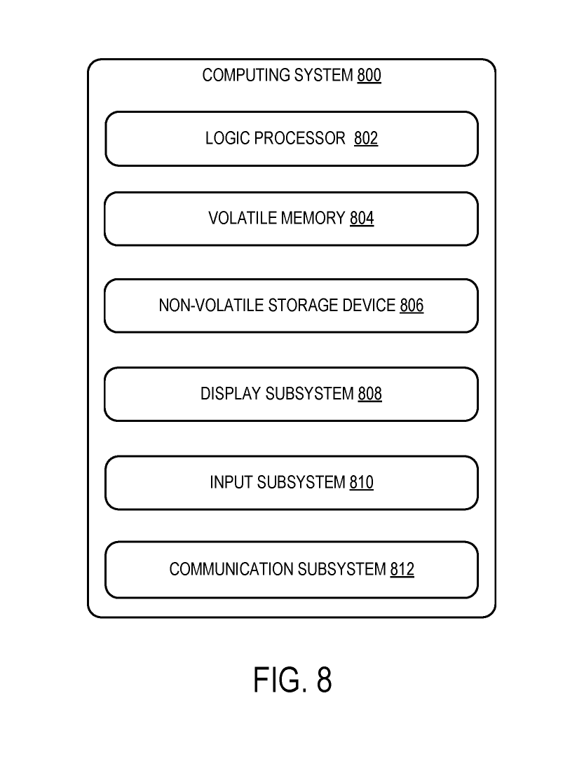

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smartphone), and/or other computing devices. Examples of the computing system 800 described above may include the computing device 22, the mobile computing device 28, the controller 38, the server 76, and/or the remote device 92.

Computing system 800 includes a logic processor 802, volatile memory 804, and a non-volatile storage device 806. Computing system 800 may optionally include a display subsystem 808, input subsystem 810, communication subsystem 812, and/or other components not shown in FIG. 8.

Logic processor 802 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 802 may include one or more processors configured to execute software instructions. Additionally or alternatively, the logic processor 802 may include one or more hardware or firmware logic processors configured to execute hardware or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 802 may be virtualized and executed by remotely accessible, networked computing devices configured in a cloud-computing configuration. In such a case, these virtualized aspects may be run on different physical logic processors of various different machines.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built-in. Non-volatile storage device 806 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “model” and “program” may be used to describe an aspect of computing system 800 typically implemented in software by a processor to perform a particular function using portions of volatile memory, which function involves transformative processing that specially configures the processor to perform the function. Thus, a program may be instantiated via logic processor 802 executing instructions held by non-volatile storage device 806, using portions of volatile memory 804. It will be understood that different programs may be instantiated from the same application, service, code block, object, library, routine, API, function, etc. Likewise, the same program may be instantiated by different applications, services, code blocks, objects, routines, APIs, functions, etc. The terms “model” and “program” may encompass individual or groups of executable files, data files, libraries, drivers, scripts, database records, etc.

When included, display subsystem 808 may be used to present a visual representation of data held by non-volatile storage device 806. This visual representation may take the form of a graphical user interface (GUI). As the methods and processes described herein change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

The following paragraphs provide additional support for the claims of the subject application. One aspect provides an air conditioning control system comprising a plurality of air vents in a space, a plurality of sensors configured to generate sensor input including an estimated temperature of at least one target surface of an occupant or object in the space, and one or more processors configured to execute a thermal control model to generate airflow parameters for each vent based on the sensor input, to control the estimated temperature to trend toward a respective target temperature for each target surface. In this aspect, additionally or alternatively, the air vents may be installed in a vehicle. In this aspect, additionally or alternatively, the plurality of sensors may be installed in the vehicle. In this aspect, additionally or alternatively, one or more of the plurality of sensors may be installed in, or are an accessory of, a mobile computing device. In this aspect, additionally or alternatively, the plurality of sensors may include one or more of a thermal sensor, a visible-light camera, and a thermographic camera. In this aspect, additionally or alternatively, the thermal control model may be pre-set and stored locally in memory associated with the one or more processors, downloaded from a server among a plurality of models based on the sensor input, or generated by the one or more processors. In this aspect, additionally or alternatively, the airflow parameters may include a flow direction of air flowing through each vent that is independently adjustable by a motor controlled by one of the one or more processors. In this aspect, additionally or alternatively, the airflow parameters may include a flowrate of air flowing through each vent that is independently adjustable by a fan controlled by one of the one or more processors. In this aspect, additionally or alternatively, the airflow parameters may include a temperature of air flowing through each vent that is independently adjustable by a Heating Ventilation and Air Conditioning (HVAC) system controlled by one of the one or more processors. In this aspect, additionally or alternatively, the sensor input may further include a three-dimensional location of the at least one target surface in the space. In this aspect, additionally or alternatively, for each occupant or object, the one or more processors may be further configured to generate and update a thermal map over time.

Another aspect provides a method for air conditioning control. The method may comprise generating sensor input including an estimated temperature of at least one target surface of an occupant or object in a space having a plurality of air vents, and controlling the estimated temperature to trend toward a respective target temperature for each target surface by generating airflow parameters for each vent based on the sensor input. In this aspect, additionally or alternatively, the air vents may be installed in a vehicle. In this aspect, additionally or alternatively, the sensor input may be generated by a plurality of sensors that are installed in, or are an accessory of, a mobile computing device. In this aspect, additionally or alternatively, the sensor input may be generated by one or more of a thermal sensor, a visible-light camera, and a thermographic camera. In this aspect, additionally or alternatively, the airflow parameters may include a flow direction of air flowing through each vent that is independently adjustable by a motor. In this aspect, additionally or alternatively, the airflow parameters may include a flowrate of air flowing through each vent that is independently adjustable by a fan. In this aspect, additionally or alternatively, the airflow parameters may include a temperature of air flowing through each vent that is independently adjustable by a Heating Ventilation and Air Conditioning (HVAC) system. In this aspect, additionally or alternatively, the sensor input may further include a three-dimensional location of the at least one target surface in the space.

Another aspect provides a method for energy efficient routing of a vehicle. The method may comprise receiving at least a beginning location and a destination, determining external conditions including at least an outdoor temperature, calculating cabin climate control settings based on at least the external conditions and sensor input of a plurality of sensors in the vehicle, and programmatically determining a route from the beginning location to the destination based on at least an energy cost associated with effecting the cabin climate control settings under the external conditions.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An air conditioning control system, comprising:
a plurality of air vents in a space;
a plurality of sensors configured to generate sensor input including an estimated temperature of at least one target surface of an occupant or object in the space; and
one or more processors configured to execute a thermal control model to generate airflow parameters for each vent based on the sensor input, to control the estimated temperature to trend toward a respective target temperature for each target surface.

2. The air conditioning control system of claim 1, wherein the air vents are installed in a vehicle.

3. The air conditioning control system of claim 2, wherein the plurality of sensors are installed in the vehicle.

4. The air conditioning control system of claim 1, wherein one or more of the plurality of sensors are installed in, or are an accessory of, a mobile computing device.

5. The air conditioning control system of claim 1, wherein the plurality of sensors includes one or more of a thermal sensor, a visible-light camera, and a thermographic camera.

6. The air conditioning control system of claim 1, wherein the thermal control model is pre-set and stored locally in memory associated with the one or more processors, downloaded from a server among a plurality of models based on the sensor input, or generated by the one or more processors.

7. The air conditioning control system of claim 1, wherein the airflow parameters include a flow direction of air flowing through each vent that is independently adjustable by a motor controlled by one of the one or more processors.

8. The air conditioning control system of claim 1, wherein the airflow parameters include a flowrate of air flowing through each vent that is independently adjustable by a fan controlled by one of the one or more processors.

9. The air conditioning control system of claim 1, wherein the airflow parameters include a temperature of air flowing through each vent that is independently adjustable by a Heating Ventilation and Air Conditioning (HVAC) system controlled by one of the one or more processors.

10. The air conditioning control system of claim 1, wherein the sensor input further includes a three-dimensional location of the at least one target surface in the space.

11. The air conditioning control system of claim 1, wherein for each occupant or object, the one or more processors are further configured to generate and update a thermal map over time.

12. A method for air conditioning control, comprising:
generating sensor input including an estimated temperature of at least one target surface of an occupant or object in a space having a plurality of air vents; and
controlling the estimated temperature to trend toward a respective target temperature for each target surface by generating airflow parameters for each vent based on the sensor input.

13. The method of claim 12, wherein the air vents are installed in a vehicle.

14. The method of claim 12, wherein the sensor input is generated by a plurality of sensors that are installed in, or are an accessory of, a mobile computing device.

15. The method of claim 12, wherein the sensor input is generated by one or more of a thermal sensor, a visible-light camera, and a thermographic camera.

16. The method of claim 12, wherein the airflow parameters include a flow direction of air flowing through each vent that is independently adjustable by a motor.

17. The method of claim 12, wherein the airflow parameters include a flowrate of air flowing through each vent that is independently adjustable by a fan.

18. The method of claim 12, wherein the airflow parameters include a temperature of air flowing through each vent that is independently adjustable by a Heating Ventilation and Air Conditioning (HVAC) system.

19. The method of claim 12, wherein the sensor input further includes a three-dimensional location of the at least one target surface in the space.

20. A method for energy efficient routing of a vehicle, the method comprising:
receiving at least a beginning location and a destination;
determining external conditions including at least an outdoor temperature;
calculating cabin climate control settings based on at least the external conditions and sensor input of a plurality of sensors in the vehicle; and
programmatically determining a route from the beginning location to the destination based on at least an energy cost associated with effecting the cabin climate control settings under the external conditions.
